(19) United States
(12) Patent Application Publication
(10) Pub. No.: US 2007/0017117 A1
(43) Pub. Date: Jan. 25, 2007

(54) APPARATUS FOR DRYING SEMICONDUCTOR SUBSTRATE

(75) Inventors: Hun-Jung YI, Gyeonggi-do, (KR); Sang-Oh PARK, Gyeonggi-do, (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-Do (KR)

(21) Appl. No.: 11/458,194

(22) Filed: Jul. 18, 2006

(30) Foreign Application Priority Data
Jul. 20, 2005 (KR) 2005-0065931

(51) Int. Cl. F26B 3/00; F26B 5/04

(52) U.S. Cl. 34/351; 34/410

(57) ABSTRACT

An apparatus for drying a substrate is provided. In one embodiment, the apparatus includes a drying room in which a support member for supporting a plurality of wafers is disposed. The apparatus further includes a drying gas-supply element for supplying a drying gas to the substrates supported by the support member. The drying gas-supply element includes nozzles located within the drying room and arranged in a plurality of groups, and supply pipes for supplying a drying gas to the nozzles. Nozzles belonging to a first group are formed such that the density of the openings in a spray port is higher in a front region than in other regions, and nozzles belonging to a second group are formed such that density of openings in a spray port is higher in a rear region than in other regions. Different supply pipes can be connected to nozzles belonging to different groups, and a flow control valve can be installed in each of the supply pipes.

### CROSS-REFERENCE TO RELATED APPLICATIONS

This application claims priority from Korean Patent Application No. 2005-65931, filed on Jul. 20, 2005, the entire contents of which are hereby incorporated by reference.

### BACKGROUND OF THE INVENTION

1. Field of the Invention

The present invention relates to an apparatus for manufacturing a semiconductor device, and more particularly, to an apparatus for drying a semiconductor substrate such as a wafer.

2. Description of the Related Art

Generally, a semiconductor device is manufactured by various unit processes such as deposition, photolithography, etching, and polishing. A cleaning process removes residual chemicals, small particles, or contaminants remaining on the surface of a semiconductor wafer as these unit processes are performed.

A cleaning process for a semiconductor wafer includes a chemical solution processing process (solution process) of etching or exfoliating impurities on the surface of a semiconductor wafer by chemical reaction, a rinsing process of rinsing a solution-processed semiconductor wafer using de-ionized (DI) water, and a drying process of drying a rinsed semiconductor wafer.

FIG. 1 is a schematic sectional view of a general drying apparatus, and FIG. 2 is a view illustrating a drying gas-supply element of FIG. 1. Referring to FIG. 1, the drying apparatus includes a drying room 10 where a drying process is performed and having a space whose upper portion is open, and a cover 40 for opening/closing the upper portion of the drying room 10 in order to seal the inside of the drying room 10 from the outside. A support member 20 for supporting wafers W such that the wafers W are vertically disposed, and an exhaust member 50 for exhausting a drying gas from the drying room 10 are provided inside the drying room 10. The drying gas is supplied to the drying room 10 through the drying gas-supply element 30.

Referring to FIG. 2, the drying gas-supply element 30 includes nozzles 32 arranged along a direction in which the wafers W are arranged within the drying room 10 and each having a plurality of spray ports 34, and a supply pipe 36 connected to each of the nozzles 32 to supply a drying gas. The spray ports 34 have the same diameter, respectively, and the interval between the spray ports 34 is equivalent over the entire region of the nozzles 32. Also, the supply pipe 36 includes a primary pipe 36a through which a drying gas is introduced from the outside, and branch pipes 36b branching off from the primary pipe 36a and connected with each of the nozzles 32. A valve 38 for controlling the flow of the drying gas flowing through the primary pipe 36a is installed at the primary pipe 36a. The same flows of the drying gases are supplied to respective nozzles 32. With such a structure, the drying gas-supply element 30 supplies a uniform amount of a drying gas to the entire region within the drying room 10.

When a uniform amount of the drying gas is supplied over the entire region of the drying room 10 to perform a drying process on a plurality of wafers W, drying uniformity of the wafers W is often different from each other. Because an airflow, pressure, and flow rate of a drying gas are different depending on a region within the drying room 10 due to structural factors such as the shape of the drying room 10 and arrangement of structures within the drying room 10, and thus, drying environments of the wafers W disposed within the drying room 10 are different from one another. Particularly, wafers W located in a front region or a rear region within the drying room 10 have a low drying efficiency compared to wafers W located in the other regions. The reason the wafers W located in the front region or the rear region have the low drying efficiency is because the wafers W, unlike wafers W located in the other regions, are located to face a lateral wall of the drying room 10, and thus have a particularly different drying environments.

Also, an amount of solution or DI water remaining on each of the wafers W before the drying process is performed may be different. When the drying process is performed on the wafers W using a general drying apparatus, the same amount of a drying gas is supplied over all of the wafers W, so that drying uniformity of the wafers W is different from one another. That is, wafers W which have a relatively large amount of solution or DI water on the surface have a low drying efficiency compared to other wafers.

Also, the drying efficiency of regions of each wafer is different from one another depending on an installation position of exhaust members 50 within the drying room 10. For example, when the exhaust members 50 are installed in both lower sides of the drying room 10, respectively, as illustrated in FIG. 1, both edge regions of the wafer contact a large amount of a drying gas and thus have excellent drying efficiency, but a center region of the wafer contacts a small amount of the drying gas and thus has a low drying efficiency.

### SUMMARY

The present invention provides, among other things, a drying apparatus for improving drying efficiency of wafers. The present invention also provides a drying apparatus for improving drying uniformity of wafers. The present invention also provides a drying apparatus for improving drying uniformity of the regions of each wafer.

An apparatus for drying a semiconductor substrate is provided. In one embodiment, the apparatus comprises a drying room defining a space where drying is performed; a support member arranged inside the drying room and on which substrates are mounted for drying; and a drying gas-supply element for providing a drying gas to the substrates mounted on the support member. The drying gas-supply element can include nozzles arranged in a plurality of groups, and a plurality of supply pipes connected to the nozzles in each group, the nozzles including flow controllers. In another embodiment, each of the nozzles include a spray port defining a plurality of openings, the density of the openings in the spray port being different in different regions of each nozzle, the nozzles arranged in the same group having a density of openings having the same array configuration, and the nozzles in different groups having a density of openings having a different array configuration. The spray ports of the nozzle are preferably provided at different intervals in different regions of the nozzle and/or in a different density in different regions of the nozzle and/or such that the density of the openings gradually increases or decreases along a direction from a region on one side to a region on the other side.

In a further embodiment, each of the nozzles is arranged in the same direction as an arrangement direction of the substrates mounted on the support member, and the drying gas-supply element includes at least one nozzle in a first group formed such that the density of openings in a spray port is higher in a front region than in other regions; and at least one nozzle in a second group formed such that the density of openings in a spray port is higher in a rear region than in other regions. In still a further embodiment, one nozzle is provided in each of the first group and the second group, and the nozzle in the first group and the nozzle in the second group are arranged in parallel with each other. In still another embodiment, one nozzle is provided in the first group, and two nozzles are provided in the second group, the nozzle in the first group being located in the center, and the nozzles in the second group being located on the sides of the nozzle in the first group, respectively. Another embodiment can be provided wherein two nozzles are provided in each of the first group and the second group, the nozzles in the first group being located in the center, and the nozzles belonging to the second group being located on outer sides of the nozzles in the first group, respectively. A further embodiment can be provided wherein a plurality of nozzles are provided in each of the first group and the second group, and the nozzles in the first group and the nozzles in the second group are alternately arranged. Still a further embodiment can be provided wherein a plurality of nozzles are provided in each of the first group and the second group, and pairs of the nozzles in the first group and pairs of the nozzles in the second group are alternatively arranged. The drying gas-supply element can further include a nozzle in a third group formed such that the density of the openings in a spray port is higher in a center region rather than in other regions.

Preferably, a plurality of nozzles are provided to each of a plurality of groups, each of the supply pipes comprise a primary pipe, at least one branch pipe connected to the primary pipe and to each of the nozzles, and each flow controller is located in the primary pipe. In an embodiment herein, a flow controller is installed in each flow pipe.

The nozzles can be arranged in the same direction as an arrangement direction of the substrates mounted on the support member, the drying gas-supply element can comprise at least one nozzle in a first group formed such that the density of the openings in a spray port is higher in a front region and a rear region than in other regions, and at least one nozzle in a second group formed such that the density of openings in a spray port is higher in a center region than in other regions. The drying gas-supply element preferably includes a nozzle in a first group arranged to supply a large amount of a drying gas to a center region of each of the substrates, and a nozzle in a second group arranged to supply a large amount of a drying gas to both edge regions of each of the substrates. Furthermore, the apparatus can include one nozzle is in the first group, and two nozzles are in the second group, the nozzle in the first group being located in the center of the drying room and the nozzles in the second group are located on both sides of the nozzle in the first group.

The drying gas preferably comprises isopropyl alcohol. The drying gas can also comprise one of a nitrogen gas and an inert gas.

Since the apparatus can supply a large amount of a drying gas to a region of each wafer that has low drying efficiency compared to other regions, drying uniformity of regions of each wafer should improve.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic cross-sectional view of a prior art drying apparatus;

FIG. 2 is an exemplary view of the drying gas-supply element of FIG. 1;

FIG. 3 is a schematic view of a drying apparatus according to the present invention;

FIG. 4 is a perspective view of the support member of FIG. 3;

FIGS. 5A through 5D are exemplary views of a nozzle of a first group and a nozzle of a second group;

FIG. 6 is a view illustrating the drying gas-supply element of FIG. 3 according to a first embodiment of the present invention;

FIG. 7 is a view illustrating supplying different amounts of a drying gas to wafers when the drying gas-supply element of FIG. 6 is used;

FIG. 8 is a view of the drying gas-supply element of FIG. 6 according to another embodiment of the present invention;

FIG. 9 is a view of the drying gas-supply element of FIG. 6 according to another embodiment of the present invention;

FIG. 10 is a view of the drying gas-supply element of FIG. 6 according to another embodiment of the present invention;

FIG. 11 is a view of the drying gas-supply element of FIG. 6 according to another embodiment of the present invention;

FIG. 12 is a view illustrating a modification of the drying gas-supply element of FIG. 9;

FIG. 13 is a view illustrating another example of a first nozzle and a second nozzle;

FIG. 14 is a view illustrating another example of the nozzles of FIG. 3;

FIGS. 15A and 15B, and FIGS. 16A and 16B are views illustrating a wafer where defects are generated when a general drying gas-supply element is used and a defect-free wafer with use of a drying gas-supply element according to the present invention;

FIG. 17 is a view of the drying gas-supply element of FIG. 3 according to another embodiment of the present invention; and

FIG. 18 is a view illustrating supplying different amounts of a drying gas to regions of each wafer when the drying gas-supply element of FIG. 17 is used.

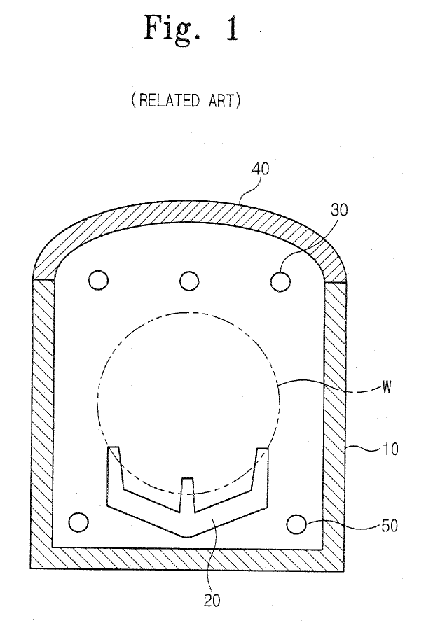

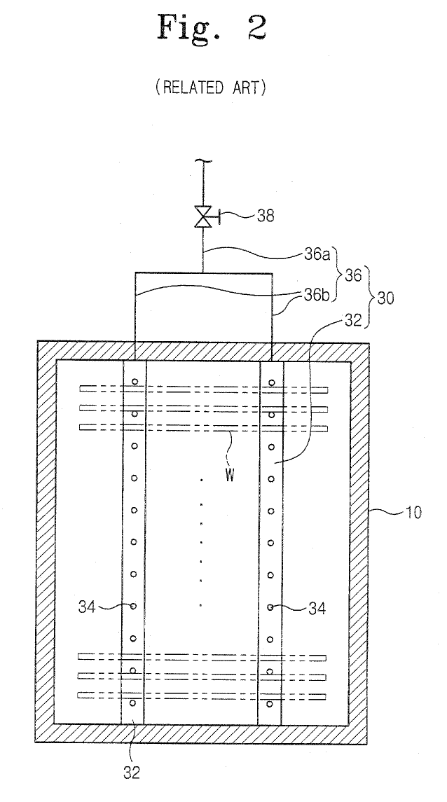

### DETAILED DESCRIPTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention. Therefore, in the drawings, the shape of an element is exaggerated for clarity.

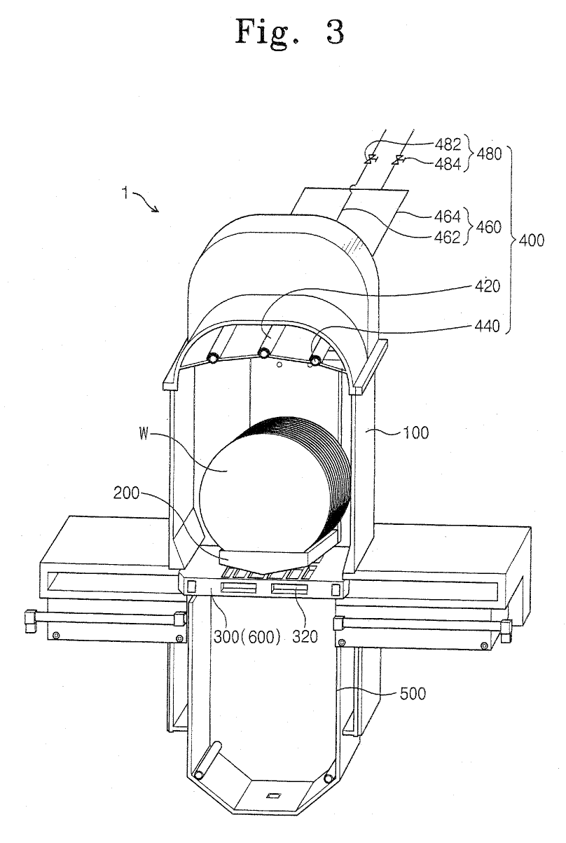

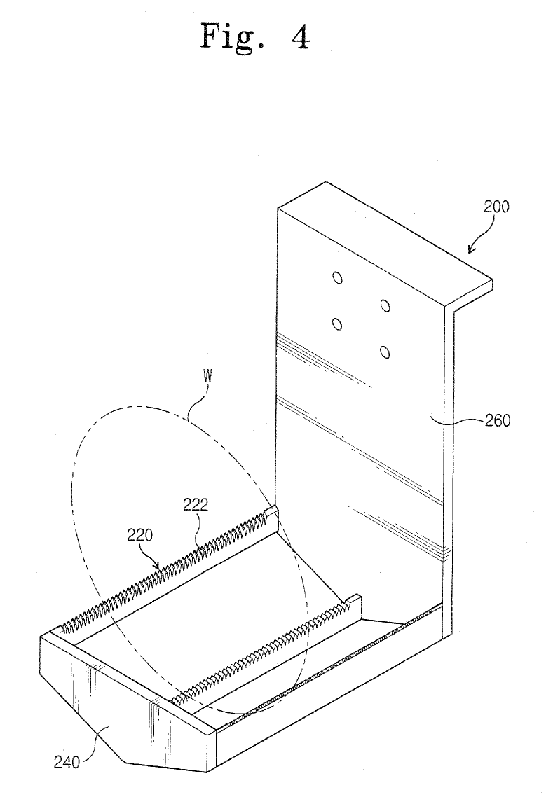

The present invention provides an apparatus 1 for drying a semiconductor substrate such as a wafer W. FIG. 3 is a schematic view of an apparatus 1 for drying a semiconductor substrate according to the present invention, and FIG. 4 is a perspective view of the support member 200 of FIG. 3. Referring to FIG. 3, the apparatus 1 includes a drying room 100, a support member 200, an exhaust member 300, and a drying gas-supply element 400. The drying room 100 provides a space sealed from the outside and in which a process is performed. A cleaning room 500 where a solution cleaning process or a rinsing process is performed on a wafer W is provided below the drying room 100. A separation plate 600 for opening/closing a passage is provided between the drying room 100 and the cleaning room 500. The exhaust member 300 is provided to the drying room 100 in order to exhaust a drying gas inside the drying room 100 to the outside. According to an embodiment of the present invention, the separation plate 600 may also serve as the exhaust member 300 as illustrated in FIG. 3. An exhaust passage 320 communicating with the inside of the drying room 100 is formed inside the separation plate 600. The exhaust passage 320 may be uniformly provided over the entire region of the separation plate 600 such that a drying gas may flow mainly in a vertical direction from the upper portion to the lower portion within the drying room 100. Unlike the exhaust passage 320, the exhaust member 300 has a rod shape in which exhaust ports (not shown) are formed, and may be located at the lower corners within the drying room 100.

The support member 200 for supporting wafers W is located inside the drying room 100. Referring to FIG. 4, the support member 200 includes support rods 220 each having a rod shape and arranged in parallel, a connection plate 240 for connecting one end of the support rods 220, and a driving plate 260 for connecting the other ends of the support rods 220. The support member 200 may be moved between the cleaning room 500 and the drying room 100 by means of a driving member (not shown) coupled to the driving plate 260. Each of the support rods 220 has slots 222 for receiving a part of the edge region of a wafer W. Each of the wafers is disposed in an upright state in the support member 200 such that a surface of each wafer on which a pattern is formed faces a lateral direction, and a plurality of wafers W are arranged in a predetermined direction and in parallel. Hereinafter, a region within the drying room 100 where the connection plate 240 is located is referred to as a front region, and a region within the drying room 100 where the driving plate 260 is located is referred to as a rear region.

The drying gas-supply element 400 supplies a drying gas to the wafers W. The drying gas-supply element 400 includes a plurality of nozzles 420 and 440, and supply pipes 460.

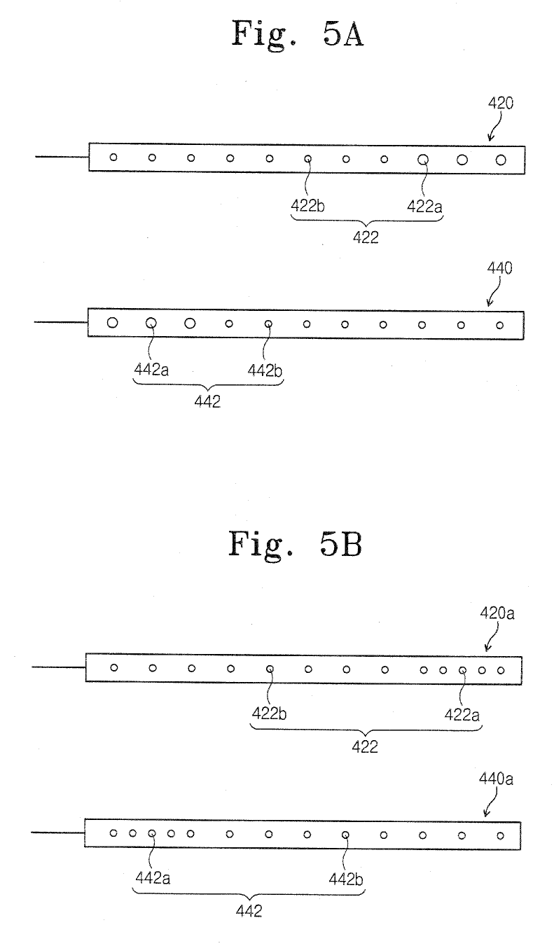

The nozzles 420 and 440 are arranged inside the drying room 100, and may be installed in a cover for opening/closing the upper portion of the drying room 100. Each of the nozzles 420 and 440 has a rod shape, and is arranged in the same direction as an arrangement direction of the wafers W disposed in the support member 200. Each of the nozzles 420 and 440 has spray ports 422 and 442 (of FIG. 5) for spraying a drying gas. The spray ports 422 and 442 are provided such that the spray ports reach from the upper region of a wafer located in a foremost side to the upper region of a wafer located in a rearmost side of the wafers W disposed in the support member 200.

The nozzles 420 and 440 are grouped into a plurality of groups. Each of the group includes at least one nozzle. The supply pipes 460 are connected to the nozzles 420 and 440 to supply a drying gas from a drying gas storage (not shown) to the nozzles 420 and 440. Different supply pipes 460 are connected to the nozzles 420 and 440 belonging to different groups, and a flow controller 480 is installed in each of the supply pipes 460 in order to control the flow of a drying gas flowing through each of the supply pipes 460. The flow controller 480 may be one of a flow control valve and a mass flow controller. The drying gas may be isopropyl alcohol (IPA) vapor. Alternatively, the drying gas may be one of a nitrogen gas and an inert gas.

FIGS. 5 through 16 are views illustrating various drying gas-supply elements 400 according to a first embodiment of the present invention. The drying gas-supply element 400 has a structure capable of supplying different amounts of a drying gas to wafers W.

Generally, the amount of a drying gas sprayed from a nozzle depends on the density of openings formed in the nozzle. When the density of the openings is large, a large amount of a drying gas is sprayed. When the density of the openings is small, a small amount of a drying gas is sprayed. The density of the openings in spray ports depends on the number of spray ports provided to a nozzle, the interval between spray ports, and a density of spray ports. According to the first embodiment, each of the nozzles 420 and 440 has a shape such that different densities of openings are achieved depending on a region of each nozzle. Therefore, an amount of a drying gas sprayed from each of the nozzles 420 and 440 is different depending on a region of each nozzle. The nozzles 420 and 440 belonging to the same group have density of openings based on the same arrangement, while the nozzles 420 and 440 belonging to different groups have density of openings based on different arrangements.

In the following examples, nozzles 420 and 440 grouped into two groups will be described. The nozzle 420 belonging to a first group has a higher density of openings in a front region rather than in other regions. The nozzles 440 belonging to a second group has a higher density of openings in a rear region rather than in other regions. Therefore, the nozzle 420 of the first group supplies a larger amount of a drying gas to wafers W located in the front region compared to wafers W located in other regions. On the other hand, the nozzle 440 of the second group supplies a larger amount of a drying gas to wafers W located in the rear region compared to wafers W located in other regions.

FIGS. 5A through 5D are various exemplary views of the nozzle 420 of a first group and the nozzle 440 of a second group.

According to one example, referring to FIG. 5A, spray ports 422a formed in the front region of the nozzle 420 of a first group have a larger diameter than spray ports 422b formed in other regions, while spray ports 442a formed in the rear region of the nozzle 440 of a second group have a larger diameter than spray ports 442b formed in other regions.

According to another example, referring to FIG. 5B, spray ports 422a formed in the front region of the nozzle 420a of a first group (referred to as a first nozzle) are densely formed in comparison with spray ports 422b formed in other regions, while spray ports 442a formed in the rear region of the nozzle 440a of a second group (referred to as a second nozzle) are densely formed in comparison with spray ports 442b formed in other regions.

In the above-described examples, the spray ports 422 and 442 formed in the nozzles 420 and 440 have high density of openings only in a predetermined region. However, unlike these examples, density of openings of sprays ports 422 and 442 formed in nozzles 420b and 440b may gradually increase or decrease along a direction from the front region to the rear region of each of the nozzles 420b and 440b. For example, referring to FIG. 5C, density of openings of the spray ports 422 formed in a first nozzle 420b may gradually increase along a direction from the rear region to the front region, while density of openings of the spray ports 442 formed in a second nozzle 440b may gradually decrease along a direction from the front region to the rear region. The increasing/decreasing of the density of the openings may be achieved by varying the density of the spray ports 422 and 442, or by varying the interval between the sprays ports 422 and 442.

Also, above descriptions have been made for a case where spray ports 422 and 442 having a plurality of holes are provided in the nozzles 420 and 440. However, unlike this case, spray ports 424 and 444 formed in nozzles 420c and 440c may be provided in slit shapes having different widths depending on a region of the nozzles. For example, referring to FIG. 5D, the width of a slit formed in a first nozzle 420c is wider in a front region than in other regions, while the width of a slit formed in a second nozzle 440c is wider in a rear region than in other regions.

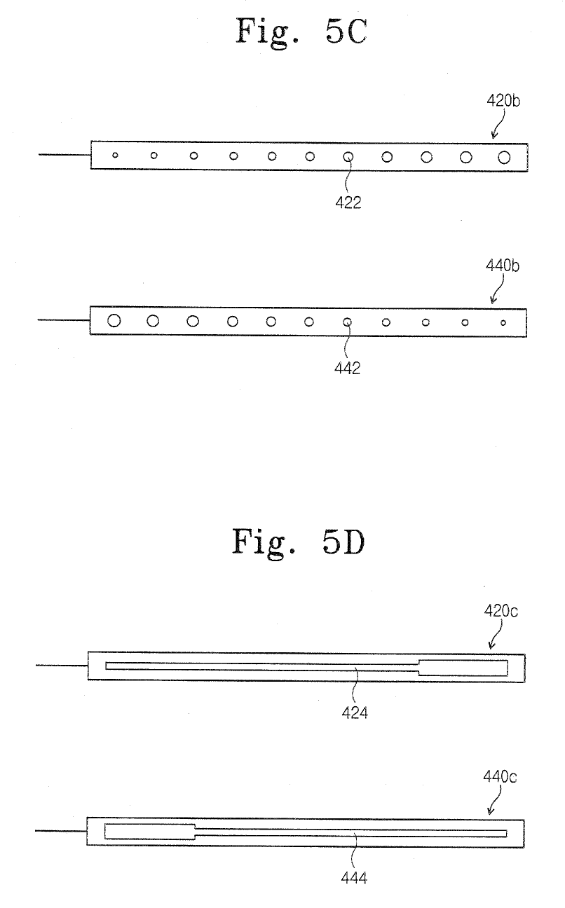

FIG. 6 is a view illustrating an example of the drying gas-supply element 400. Referring to FIG. 6, the drying gas-supply element includes two nozzles 420 and 440, supply pipes 460, and flow control valves 480. One first nozzle 420 is provided to a first group, and one second nozzle 440 is provided to a second group. The first nozzle 420 and the second nozzle 440 are arranged in parallel. A first supply pipe 462 where a first flow control valve 482 is installed is connected to the first nozzle 420, and a second supply pipe 464 where a second flow control valve 484 is installed is connected to the second nozzle 440.

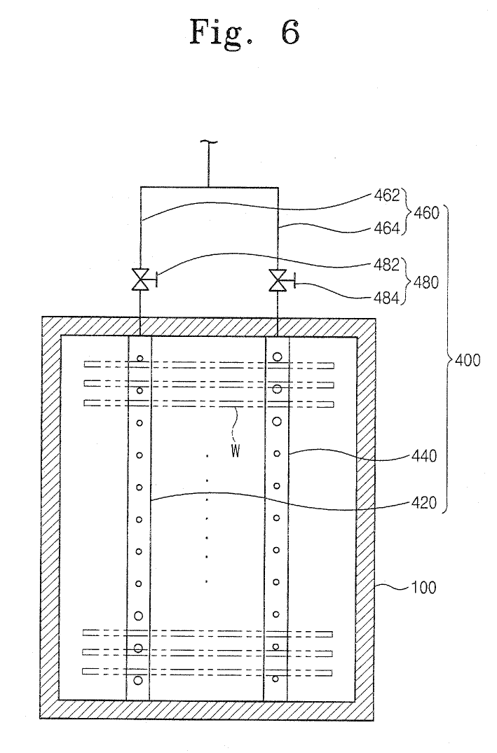

FIG. 7 is a view illustrating different amounts of a drying gas are supplied depending on a region within the drying room 100 when the drying gas-supply element 400 of FIG. 6 is used. Descriptions will be made using a case where wafers Wf located in a front region are not properly dried than wafers Wr located in other regions among the wafers W mounted on the support member 200. Since a larger amount of a drying gas should be supplied to the front region rather than to the rear region, a large amount of the drying gas is supplied to the first nozzle 420 rather than to the second nozzle 440. Therefore, the opening rate of the first flow control valve 482 should be larger than that of the second flow control valve 484. For example, the first flow control valve 482 is 100% opened, and the second flow control valve 484 is 50% opened.

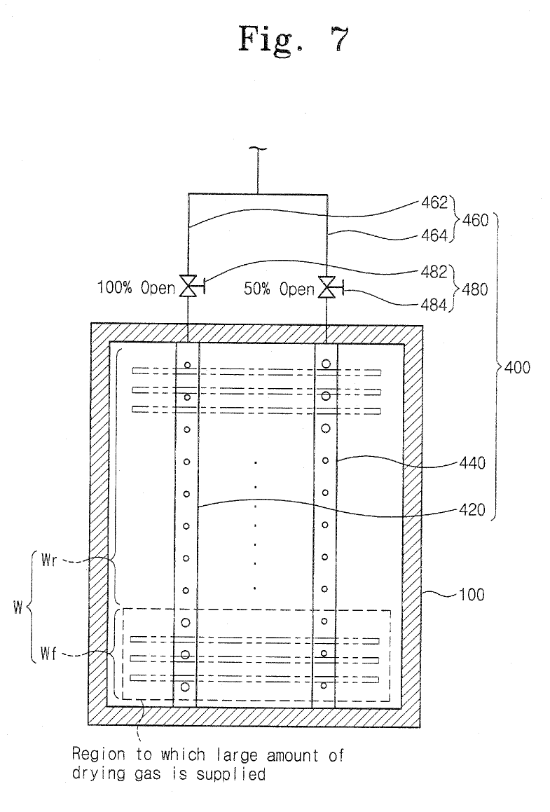

FIG. 8 is a view illustrating another example of the drying gas-supply element 400. Referring to FIG. 8, the drying gas-supply element includes three nozzles 420 and 440. One first nozzle 420 is provided to a first group, and two second nozzles 440 are provided to a second group. The first nozzle 420 is located above the center of wafers W inside a drying room 100, and the second nozzles 440 are located in both sides of the first nozzle 420, respectively. A first supply pipe 462 where a first flow control valve 482 is installed is connected to the first nozzle 420 and a second supply pipe 464 is connected to the second nozzles 440. The second supply pipe 464 includes a primary pipe 464a where a second flow control value 484 is installed, and branch pipes 464b branching off from the primary pipe 464a and connected with the second nozzles 440, respectively.

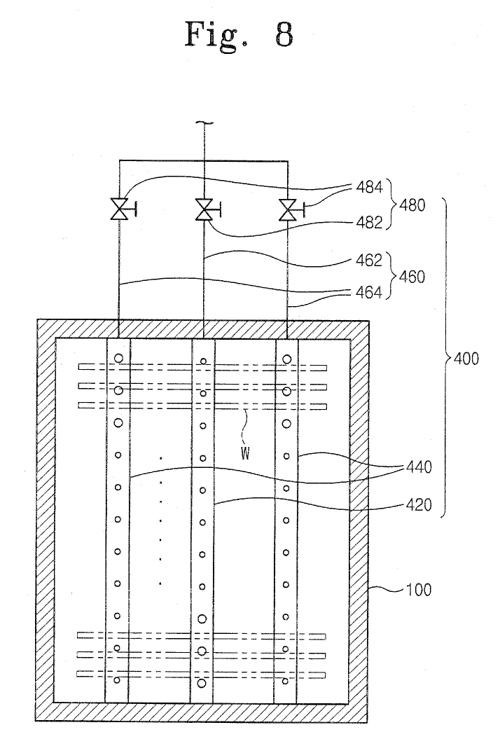

FIG. 9 is a view illustrating another example of the drying gas-supply element 400. Referring to FIG. 9, the drying gas-supply element includes four nozzles 420 and 440. Two first nozzles 420 are provided to a first group, and two second nozzles 440 are provided to a second group. The first nozzles 420 are arranged in parallel in the center region inside the drying room 100, and the second nozzles 440 are arranged in both lateral regions inside the drying room 100, respectively. A first supply pipe 462 is connected to the first nozzles 420, and a second supply pipe 464 is connected to the second nozzles 440. The first supply pipe 462 includes a primary pipe 462a where a first flow control valve 482 is installed, and branch pipes 462b branching off from the primary pipe 462a and connected with the first nozzles 420, respectively. The second supply pipe 464 includes a primary pipe 464a where a second flow control valve 484 is installed, and branch pipes 464b branching off from the primary pipe 464a and connected with the second nozzles 440, respectively.

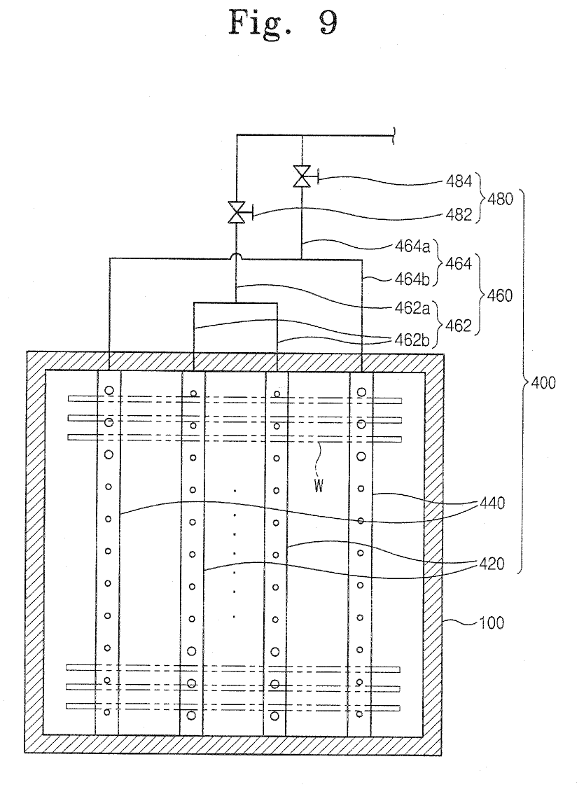

FIG. 10 is a view illustrating another example of the drying gas-supply element 400. Referring to FIG. 10, the drying gas-supply element includes six nozzles 420 and 440. Two first nozzles 420 are provided to a first group, four second nozzles 440 are provided to a second group. The first nozzles 420 are arranged in the center region inside the drying room 100, and two second nozzles 440 are arranged in both lateral regions inside the drying room 100, respectively. A first supply pipe 462 is connected to the first nozzles 420, and a second supply pipe 464 is connected to the second nozzles 440. The first supply pipe 462 includes a primary pipe 462a where a first flow control valve 482 is installed, and branch pipes 462b branching off from the primary pipe 462a and connected with the first nozzles 420, respectively. The second supply pipe 464 includes a primary pipe 464a where a second flow control valve 484 is installed, and branch pipes 464b branching off from the primary pipe 464a and connected with the second nozzles 440, respectively.

In FIGS. 8 through 10, descriptions wherein the first nozzles 420 are located in the center region within the drying room 100, and the second nozzles 440 are located in both lateral sides inside the drying room 100. However, the number and the position of the first nozzles 420 and the second nozzles 440 may be interchangeable.

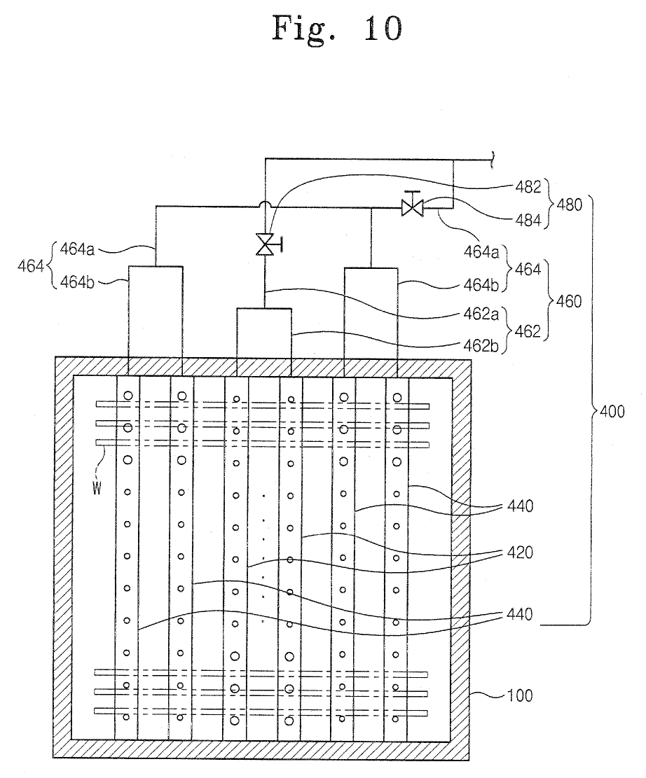

FIG. 11 is a view illustrating another example of the drying gas-supply element 400. Referring to FIG. 11, a plurality of first nozzles 420 are provided to a first group, and a plurality of second nozzles 440 are provided to a second group. The first nozzles 420 are uniformly arranged over the entire region within the drying room 100, and the second nozzles 440 are arranged between the first nozzles 420. That is, the first nozzles 420 and the second nozzles 440 may be alternately arranged. Such arrangement is particularly useful when an inner space of the drying room 100 is wide. However, the nozzles 420 belonging to the first group and the nozzles 440 belonging to the second group may be alternatively arranged in a bundle. The nozzles 420 and the nozzles 440 may be alternatively arranged in pairs. A first supply pipe 462 is connected to the first nozzles 420, and a second supply pipe 464 is connected to the second nozzles 440. The first supply pipe 462 includes a primary pipe 462a where a first flow control valve 482 is installed, and branch pipes 462b branching off from the primary pipe 462a and connected with the first nozzles 420, respectively. The second supply pipe 464 includes a primary pipe 464a where a second flow control valve 484 is installed, and branch pipes 464b branching off from the primary pipe 464a and connected with the second nozzles 440, respectively.

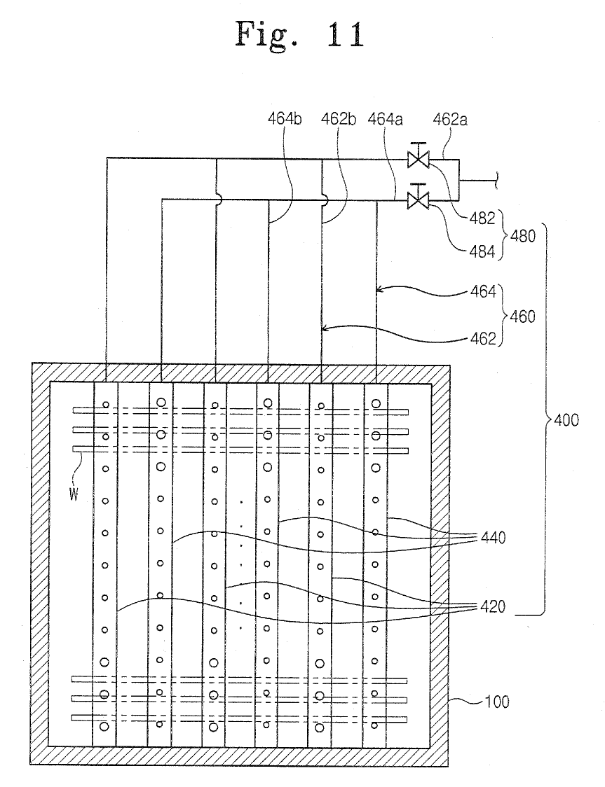

In FIGS. 9 through 11, one supply pipe including one primary pipe and a plurality of branch pipes is connected to each of nozzles belonging to the same group. However, referring to FIG. 12, a first supply pipe 462 where a first flow control valve 482 is installed is connected to each of first nozzles 420, and a second supply pipe 464 where a second flow control valve 484 is installed is connected to each of second nozzles 440.

Above descriptions have been made using a case where the nozzles 420 and 440 in a front region or a rear region have high density of openings compared to other regions. However, the nozzles may also have a low density of openings in the front region or the rear region rather than other regions.

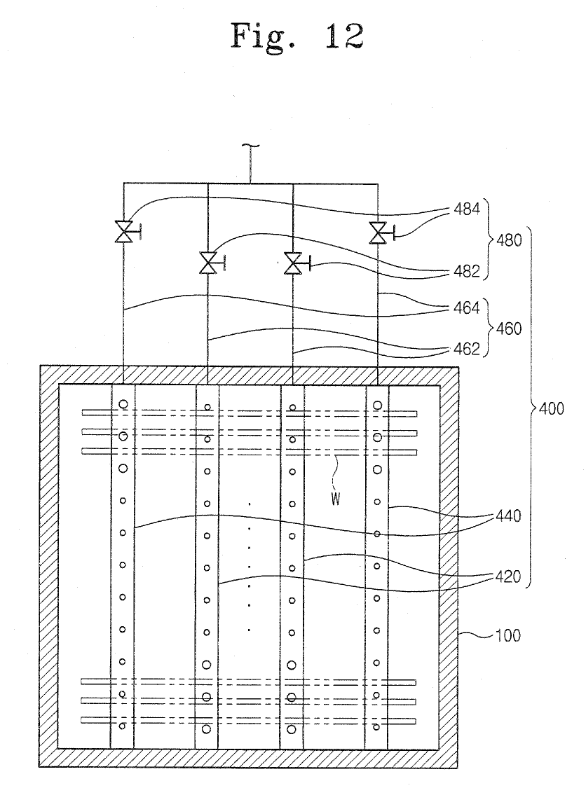

Also, in the above-described examples, the nozzles 420 belonging to the first group have high density of openings in the front region, and the nozzles 440 belonging to the second group have high density of openings in the rear region. However, unlike this, referring to FIG. 13, nozzles 420d belonging to a first group may have high density of openings in a front region and a rear region compared to a center region, and nozzles 440d belonging to a second group may have high density of openings in a center region compared to a front region and a rear region.

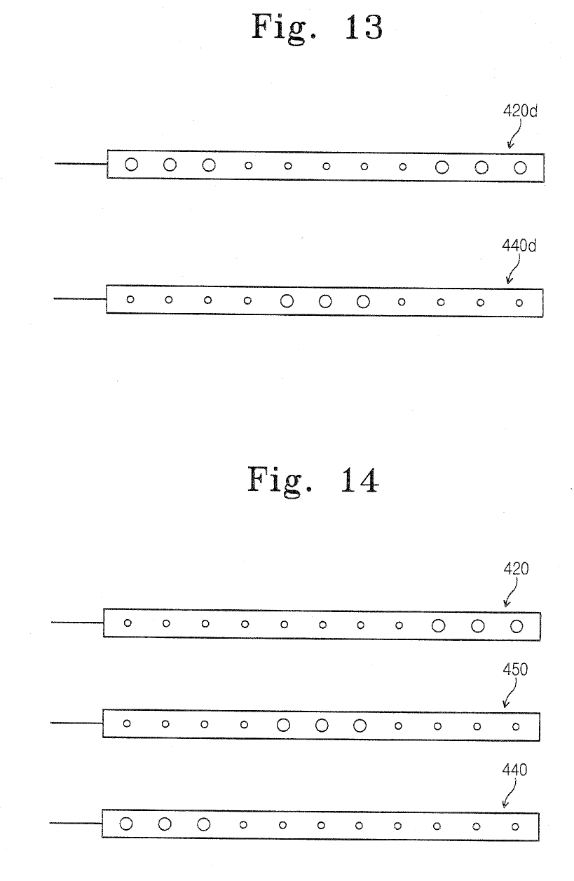

Also, in the above-described examples, the nozzles 420 and 440 have been grouped into two groups. However, unlike this, the nozzles may be grouped into more than three groups. When the nozzles are grouped into three groups, referring to FIG. 14, a third group to which nozzles 450 having high density of openings in a center region belong may be further provided.

Also, in the above-described examples, the nozzles have been arranged in the same direction as an arrangement direction of the wafers, and the density of openings in the sprays ports formed in the nozzles is different depending on a region of a wafer. However, unlike this, the nozzles may be arranged in a direction perpendicular to an arrangement direction of wafers, and different supply pipes may be connected to nozzles belonging to different groups. In this case, the nozzles may have same density of openings over the entire region of a wafer.

Since the apparatus according to the first embodiment of the present invention includes the drying gas-supply element 400 for supplying different amounts of a drying gas to wafers W, drying uniformity of wafers may improve.

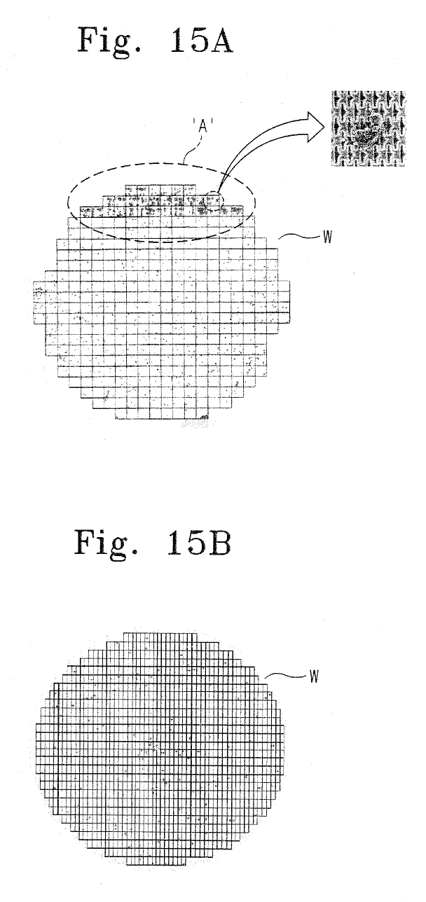

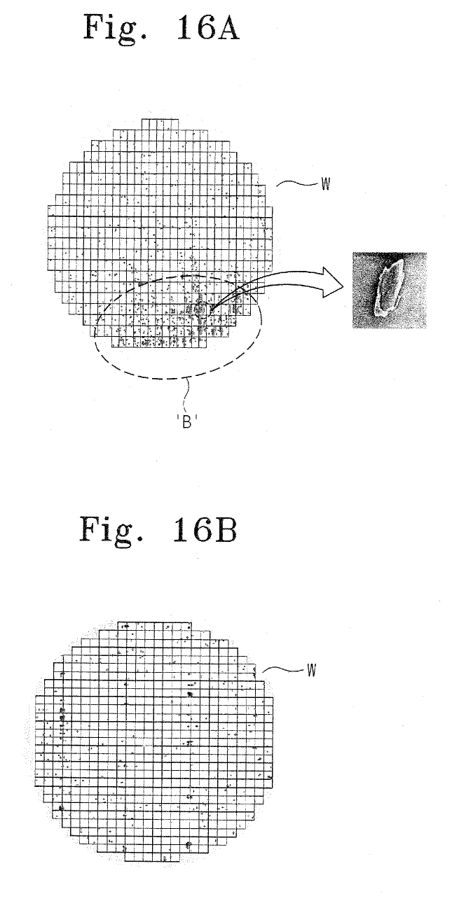

FIGS. 15 and 16 are views illustrating effects when the drying apparatus according to the first embodiment of the present invention is used.

When the same amount of IPA is supplied to the entire region of the drying room 100, a defect in which foreign substances gather is often found on the upper portion A of a wafer W located in a forwardmost side as illustrated in FIG. 15A. In this case, it is possible to remove the above-mentioned defect by controlling the amount of IPA supplied to a front region as illustrated in FIG. 15B.

Also, when the same amount of IPA is supplied to the entire region of the drying room 100, a defect in which foreign substances remain in an upward direction is often found in a lower portion B of a wafer located in a rearwardmost side as illustrated in FIG. 16A. In this case, it is possible to remove the above-mentioned defect by controlling the amount of IPA supplied to a rear region rather than to other regions as illustrated in FIG. 16B.

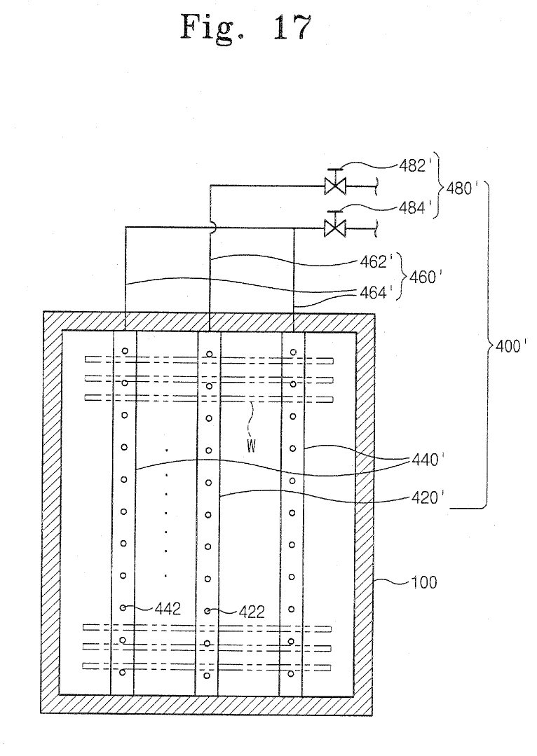

FIG. 17 is a view of a drying gas-supply element 400′ according to a second embodiment of the present invention. Unlike the first embodiment, the drying gas-supply element 400′ may supply different amounts of a drying gas to regions (e.g., a center region or both edge regions) of each wafer.

Referring to FIG. 17, the drying gas-supply element 400′ includes nozzles 420′ and 440′ grouped into a plurality of groups. For example, the drying gas-supply element 400′ includes nozzles 420′ and 440′ grouped into two groups, and a supply pipe 460′ for supplying a drying gas to these nozzles 420′ and 440′ and having a flow controller 480′. At least one nozzle 420′ is provided to a first group, and a plurality of nozzles 440′ are provided to a second group. The nozzle 420′ belonging to the first group is located in the center of a drying room 100 along an arrangement direction of wafers W, and the nozzles 440′ belonging to the second group are located in both lateral sides inside the drying room 100 and in parallel to the nozzle 420′. Therefore, the nozzle 420′ belonging to the first group supplies a larger amount of a drying gas to a center region of a wafer W compared to both edge regions of the wafer W, while the nozzles 440′ belonging to the second group supply a larger amount of a drying gas to both edge regions of a wafer W compared to a center region of the wafer W. Each of the nozzle 420′ belonging to the first group and the nozzles 440′ belonging to the second group has uniform density of openings. Alternatively, the nozzle 420′ belonging to the first group and the nozzles 440′ belonging to the second group may have different density of openings, respectively, depending on a region of a wafer.

A first supply pipe 462′ where a first flow control valve 482′ is installed is connected to the nozzle 420′ belonging to the first group, and a second supply pipe 464′ where a second flow control valve 484′ is installed is connected to the nozzles 440′ belonging to the second group. Therefore, it is possible to supply different amount of a drying gas to regions of each wafer W by controlling amounts of the drying gas supplied to the nozzle 420′ belonging to the first group and the nozzles 440′ belonging to the second group.

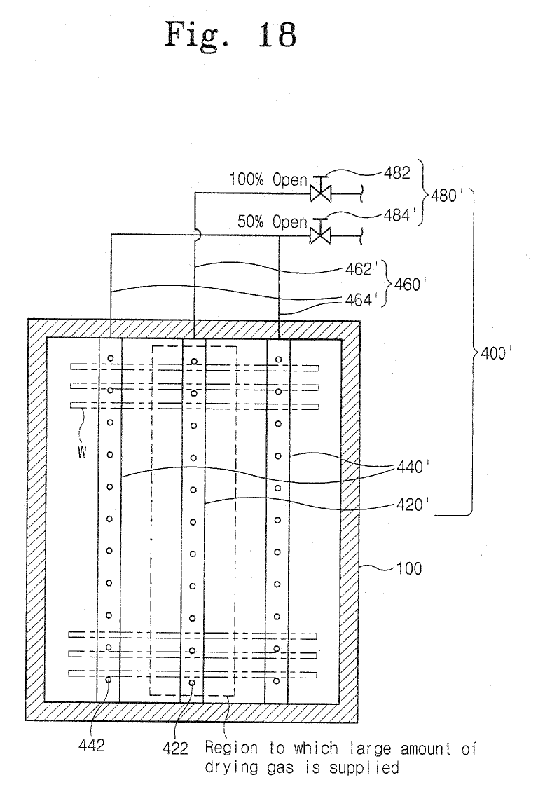

FIG. 18 is a view illustrating different amounts of a drying gas are supplied to regions of each wafer when the drying gas-supply element of FIG. 17 is used. The description is directed to a case where a center region of a wafer mounted on a support member 200 is not properly dried in comparison with both edge regions.

Since a larger amount of a drying gas should be supplied to the center region rather than to both edge regions, a large amount of the drying gas is supplied to the first nozzle 420′ rather than to the second nozzle 440′. Therefore, the opening rate of the first flow control valve 482′ should be larger than that of the second flow control valve 484′. For example, the first flow control valve 482′ is 100% opened, and the second flow control valve 484′ is 50% opened.

According to the present invention, since a larger amount of a drying gas is supplied to a region where wafers having low drying efficiency are disposed, drying uniformity of wafers will typically be improved. Also, since a larger amount of a drying gas is supplied to regions having low drying efficiency in each wafer, drying uniformity of regions of each wafer will typically be improved.

It will be apparent to those skilled in the art that various modifications and variations can be made in the present invention. Thus, it is intended that the present invention covers the modifications and variations of this invention, provided they come within the scope of the appended claims and their equivalents.

What is claimed is:

1. An apparatus for drying a semiconductor substrate, the apparatus comprising:
a drying room defining a space where drying is performed;
a support member arranged inside the drying room and on which substrates are mounted for drying; and
a drying gas-supply element for providing a drying gas to the substrates mounted on the support member, the drying gas-supply element including nozzles arranged in a plurality of groups, and a plurality of supply pipes connected to the nozzles in each group, said nozzles including flow controllers.

2. The apparatus of claim 1, wherein each of the nozzles include a spray port defining a plurality of openings, the density of the openings in said spray port being different in different regions of each nozzle, the nozzles arranged in the same group having a density of openings comprising the same array configuration, and the nozzles in different groups having a density of openings comprising a different array configuration.

3. The apparatus of claim 1, wherein each of the nozzles is arranged in the same direction as an arrangement direction of the substrates mounted on the support member, and the drying gas-supply element includes at least one nozzle in a first group is formed such that the density or the openings in a spray port is higher in a front region than in other regions; and at least one nozzle in a second group is formed such that the density of openings in a spray port is higher in a rear region than in other regions.

4. The apparatus of claim 3, wherein one nozzle is provided in each of the first group and the second group, and the nozzle in the first group and the nozzle in the second group are arranged in parallel with each other.

5. The apparatus of claim 3, wherein one nozzle is provided in the first group, and two nozzles are provided in the second group, the nozzle in the first group being located in the center, and the nozzles in the second group being located on the sides of the nozzle in the first group, respectively.

6. The apparatus of claim 3, wherein two nozzles are provided in each of the first group and the second group, the nozzles in the first group being located in the center, and the nozzles belonging to the second group being located on outer sides of the nozzles in the first group, respectively.

7. The apparatus of claim 3, wherein a plurality of nozzles are provided in each of the first group and the second group, and the nozzles in the first group and the nozzles in the second group are alternately arranged.

8. The apparatus of claim 3, wherein a plurality of nozzles are provided in each of the first group and the second group, and pairs of the nozzles in the first group and a plurality of the nozzles in the second group are alternatively arranged.

9. The apparatus of claim 1, wherein a plurality of nozzles are provided to each of a plurality of groups; and
each of the supply pipes comprise a primary pipe, and at least one branch pipe connected to the primary pipe and to each of the nozzles, and each flow controller is located in the primary pipe.

10. The apparatus of claim 1, wherein a flow controller is installed in each flow pipe.

11. The apparatus of claim 2, wherein spray ports of the nozzle are provided at different intervals in different regions of the nozzle.

12. The apparatus of claim 2, wherein spray ports of the nozzle are provided in a different density in different regions of the nozzle.

13. The apparatus of claim 2, wherein spray ports of the nozzles are provided such that the density of the openings gradually increases or decreases along a direction from a region on one side to a region on the other side.

14. The apparatus of claim 3, wherein the drying gas-supply element further includes a nozzle in a third group formed such that the density of the openings in a spray port is higher in a center region rather than in other regions.

15. The apparatus of claim 1, wherein each of the nozzles is arranged in the same direction as an arrangement direction of the substrates mounted on the support member; and
the drying gas-supply element comprises at least one nozzle in a first group formed such that the density of the openings in a spray port is higher in a front region and a rear region than in other regions; and at least one nozzle in a second group formed such that the density of openings in a spray port is higher in a center region than in other regions.

16. The apparatus of claim 1, wherein the drying gas-supply element includes a nozzle in a first group and arranged to supply a large amount of a drying gas to a center region of each of the substrates; and a nozzle in a second group arranged to supply a large amount of a drying gas to both edge regions of each of the substrates.

17. The apparatus of claim 16, wherein one nozzle is in the first group, and two nozzles are in the second group, the nozzle in the first group is located in the center of the drying room and the nozzles in the second group are located on both sides of the nozzle in the first group.

18. The apparatus of claim 1, wherein the drying gas comprises isopropyl alcohol.

19. The apparatus of claim 1, wherein the drying gas comprises one of a nitrogen gas and an inert gas.

20. An apparatus for drying a semiconductor substrate, the apparatus comprising:
a drying room defining a space where drying is performed;
a support member arranged inside the drying room, the support member adapted for mounting substrates thereon for drying; and
a drying gas-supply element for providing a drying gas to the substrates mounted on the support member, the drying gas-supply element including nozzles arranged in a plurality of groups, and a plurality of supply pipes connected to the nozzles in each group, said nozzles including flow controllers, wherein each of the nozzles include a spray port defining a plurality of openings, the density of the openings in said spray port being different in different regions of each nozzle, the nozzles arranged in the same group having a density of openings having the same array configuration, the nozzles in different groups having a density of openings having a different array configuration, and the spray ports of the nozzle are provided in a different density in different regions of the nozzle.
